(19) United States
(12) Patent Application Publication
(10) Pub. No.: US 2019/0232960 A1
(43) Pub. Date: Aug. 1, 2019

(54) VEHICLE CONTROL APPARATUS

(71) Applicant: TOYOTA JIDOSHA KABUSHIKI KAISHA, Toyota-shi (JP)

(72) Inventor: Masataka YOKOTA, Tokyo-to (JP)

(73) Assignee: TOYOTA JIDOSHA KABUSHIKI KAISHA, Toyota-shi (JP)

(21) Appl. No.: 16/240,098

(22) Filed: Jan. 4, 2019

(30) Foreign Application Priority Data
Jan. 26, 2018 (JP) 2018-011177

(51) Int. Cl. B60W 30/16; B60W 30/18; B60W 30/095

(52) U.S. Cl. CPC B60W 30/16; B60W 2550/30; B60W 30/095; B60W 30/18163

(57) ABSTRACT

A vehicle control apparatus is provided with: a risk degree determinator configured to determine a risk degree of a preceding vehicle, which runs ahead of a host vehicle, on the basis of at least one of a loading aspect and a behavior associated with the preceding vehicle; a setting device configured to set a passing aspect, which is for the host vehicle to pass the preceding vehicle, and configured to set the passing aspect when it is determined that the risk degree of the preceding vehicle is relatively high, to reduce a risk associated with passing in comparison with the passing aspect when it is determined that the risk degree of the preceding vehicle is relatively low; and a controller configured to control the host vehicle to pass the preceding vehicle in the set passing aspect.

### CROSS-REFERENCE TO RELATED APPLICATIONS

This application is based upon and claims the benefit of priority of the prior Japanese Patent Application No. 2018-011177, filed on Jan. 26, 2018, the entire contents of which are incorporated herein by reference.

### BACKGROUND

### 1. Technical Field

Embodiments of the present disclosure relate to a vehicle control apparatus.

### 2. Description of the Related Art

For this type of apparatus, for example, there is proposed an apparatus configured to notify a driver of information for determining passing possibility if a distance of an empty space in front of a preceding vehicle, which runs ahead of a host vehicle or a subject vehicle, is greater than or equal to a safe distance that allows the host vehicle to safely pass the preceding vehicle (refer to Japanese Patent Application Laid Open No. 2007-108967 (Patent Literature 1)).

Some behavior of the preceding vehicle or the like possibly makes the driver of the host vehicle feel like passing the preceding vehicle soon. This point is not considered in a technology/technique disclosed in the Patent Literature 1, which still leaves room for improvement.

### SUMMARY

In view of the aforementioned problem, it is therefore an object of embodiments of the present disclosure to provide a vehicle control apparatus that allows a vehicle to pass a preceding vehicle in view of the behavior of the preceding vehicle or the like, which may influence a driver's psychological state.

The above object of embodiments of the present disclosure can be achieved by a vehicle control apparatus provided with: a risk degree determinator configured to determine a risk degree of a preceding vehicle, which runs ahead of a host vehicle, on the basis of at least one of a loading aspect and a behavior associated with the preceding vehicle; a setting device configured to set a passing aspect, which is for the host vehicle to pass the preceding vehicle, and configured to set the passing aspect when it is determined that the risk degree of the preceding vehicle is relatively high, to reduce a risk associated with passing in comparison with the passing aspect when it is determined that the risk degree of the preceding vehicle is relatively low; and a controller configured to control the host vehicle to pass the preceding vehicle in the set passing aspect.

### BRIEF DESCRIPTION OF THE DRAWINGS

FIG. 1 is a block diagram illustrating a configuration of a vehicle control apparatus according to a first embodiment;

FIG. 2 is a flowchart illustrating a vehicle control process according to the first embodiment;

FIG. 3 is a flowchart illustrating a vehicle control process according to a second embodiment; and

FIG. 4 is a flowchart illustrating a vehicle control process according to a third embodiment.

### DETAILED DESCRIPTION OF THE EMBODIMENTS

A vehicle control apparatus according to embodiments will be explained with reference to the drawings.

### First Embodiment

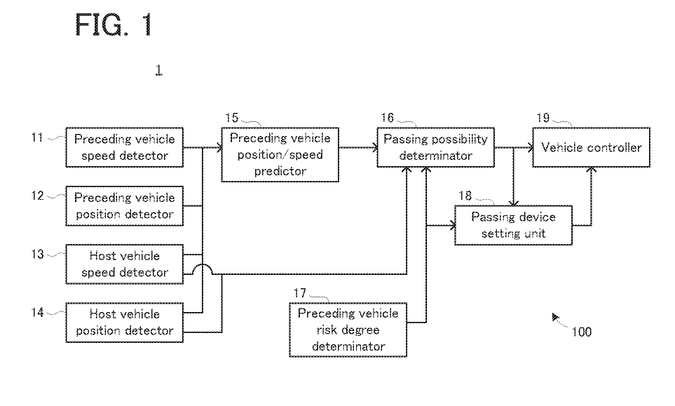

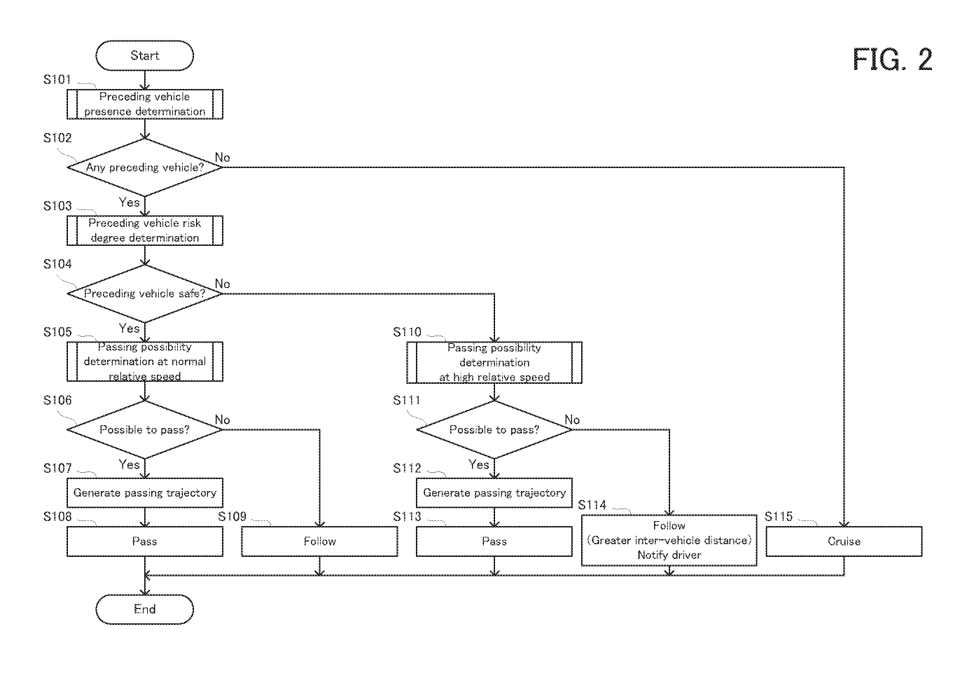

A vehicle control apparatus according to a first embodiment will be explained with reference to FIG. 1 and FIG. 2.

(Configuration)

A configuration of the vehicle control apparatus according to the first embodiment will be explained with reference to FIG. 1. FIG. 1 is a block diagram illustrating the configuration of the vehicle control apparatus according to the first embodiment.

In FIG. 1, a vehicle control apparatus 100 is mounted on a vehicle 1 and is configured to automatically drive the vehicle 1. The vehicle control apparatus 100 is provided with a preceding vehicle speed detector 11, a preceding vehicle position detector 12, a host vehicle speed detector 13, a host vehicle position detector 14, a preceding vehicle position/speed predictor 15, a passing possibility determinator 16, a preceding vehicle risk degree determinator 17, a passing device setting unit 18, and a vehicle controller 19.

Here, a “preceding vehicle” may mean a vehicle that runs just ahead of the vehicle 1 and that is a passing target of the vehicle 1. Whether the vehicle is the passing target or not may be determined, for example, by determining whether or not the vehicle runs on the same lane as that of the vehicle 1 in a predetermined range (e.g., 200 meters) ahead of the vehicle 1.

The preceding vehicle speed detector 11 is configured to detect a vehicle speed of the preceding vehicle (e.g., a relative speed of the preceding vehicle to the vehicle 1), for example, on the basis of an output of a measuring instrument, such as a millimeter wave radar, which is provided in a front part of the vehicle 1. The preceding vehicle position detector 12 is configured to detect a position of the preceding vehicle (e.g., a relative position of the preceding vehicle to the vehicle 1), for example, on the basis of the output of the measuring instrument, such as a millimeter wave radar, which is provided in the front part of the vehicle 1, and/or an output of a camera, which is configured to image or photograph a scene ahead of the vehicle 1, or the like.

The host vehicle speed detector 13 is configured to detect a vehicle speed of the vehicle 1, for example, on the basis of an output of a vehicle speed sensor, which is provided for the vehicle 1. The host vehicle position detector 14 is configured to detect a position of the vehicle 1, for example, by using a global positioning system (GPS) or the like.

The preceding vehicle position/speed predictor 15 is configured to predict a position and a speed of the preceding vehicle, on the basis of outputs of the preceding vehicle speed detector 11, the preceding vehicle position detector 12, the host vehicle speed detector 13, and the host vehicle position detector 14.

The existing various aspects can be applied to detect the vehicle speed and the position of the preceding vehicle, to detect the vehicle speed and the position of the vehicle 1, and to predict the position and the speed of the preceding vehicle. An explanation of the details will be thus omitted.

The passing possibility determinator 16 is configured to determine whether or not it is possible to pass the preceding vehicle, on the basis of outputs of the preceding vehicle position/speed predictor 15, the host vehicle speed detector 13, and the host vehicle position detector 14. The passing possibility determinator 16 is configured to determine that it is possible to pass the preceding vehicle if a passing possibility condition is satisfied, such as, for example, (i) there is a passing lane, (ii) there is a sufficient space on the passing lane, (iii) a present speed of the vehicle 1 is greater than or equal to a present speed of the preceding vehicle by a predetermined value (e.g., 5 km/h), (iv) a target speed of the vehicle 1 when passing the preceding vehicle is less than or equal to a speed limit, or similar conditions.

The preceding vehicle risk degree determinator 17 is configured to determine a risk degree of the preceding vehicle. Specifically, the preceding vehicle risk degree determinator 17 is configured to estimate a variation amount of a travel trajectory of the preceding vehicle with respect to a basic track of the preceding vehicle (e.g., a lane center), from a time change in the position and the speed of the preceding vehicle predicted by the preceding vehicle position/speed predictor 15, and from the basic track of the preceding vehicle. The preceding vehicle risk degree determinator 17 is also configured to determine the risk degree on the basis of the variation amount in a predetermined period (e.g., 5 seconds). Alternatively, the preceding vehicle risk degree determinator 17 is configured to perform frequency analysis on a time change of a difference between the basic track of the preceding vehicle and the travel trajectory of the preceding vehicle, and is configured to determine the risk degree on the basis of a peak frequency.

Here, the risk degree may be defined in a plurality of gradations or in two gradations (i.e., “0”, “1”). When the risk degree is defined in the plurality of gradations, the preceding vehicle risk degree determinator 17 may increase the risk degree with an increase in the variation amount in the predetermined amount increases, or may increase the risk degree with a reduction in the peak frequency. On the other hand, when the risk degree is defined in the two gradations, the preceding vehicle risk degree determinator 17 may determine that it is dangerous (i.e., “1”) if the variation amount in the predetermined amount exceeds a threshold value, or may determine that it is dangerous if the peak frequency is in a predetermined range.

The preceding vehicle risk degree determinator 17 is further configured to estimate a loading aspect of the preceding vehicle, for example, on the basis of an image from the camera, which is configured to image or photograph the scene ahead of the vehicle 1. The preceding vehicle risk degree determinator 17 may increase the risk degree (in the case of the plurality of gradations) or may determine that it is dangerous (in the case of the two gradations), if the estimated loading aspect is, for example, (i) not firmly fixing a load, (ii) loading gravel, sand, etc.

The passing device setting unit 18 is configured to set a passing aspect when the vehicle 1 passes the preceding vehicle. The passing device setting unit 18 may set, for example, a speed, a driving route, or the like of the vehicle 1 when passing the preceding vehicle, as the passing aspect. Particularly in the first embodiment, the passing device setting unit 18 is configured to change the passing aspect, on the basis of a determination result of the preceding vehicle risk degree determinator 17. The details will be described later.

The vehicle controller 19 is configured to control the vehicle 1 in such a manner that the vehicle 1 runs in the passing aspect set by the passing device setting unit 18, if it is determined by the passing possibility determinator 16 that it is possible to pass the preceding vehicle.

(Vehicle Control Process)

Next, a vehicle control process performed by the vehicle control apparatus 100 will be explained with reference to a flowchart in FIG. 2. The vehicle control process illustrated in FIG. 2 may be performed mainly when the vehicle control apparatus 100 automatically drives the vehicle 1.

In FIG. 2, the vehicle control apparatus 100 determines whether or not there is a preceding vehicle ahead of the vehicle 1, on the basis of the output of the measuring instrument, such as a millimeter wave radar, which is provided in the front part of the vehicle 1, and/or the output of the camera, which is configured to image or photograph a scene ahead of the vehicle 1, or the like (step S101). In the step S101, for example, if there is a vehicle that runs on the same lane as that of the vehicle 1 in a predetermined range ahead of the vehicle 1, it is determined that there is a preceding vehicle, and if there is no vehicle that runs on the same lane as that of the vehicle 1 in the predetermined range ahead of the vehicle 1, it is determined that there is no preceding vehicle.

The vehicle control apparatus 100 determines whether or not there is a preceding vehicle, on the basis of a result of the step S101 (step S102). In the determination, if it is determined that there is no preceding vehicle (the step S102: No), the vehicle controller 19 (refer to FIG. 1) controls the vehicle 1 in such a manner that the vehicle 1 runs in an aspect with the best fuel efficiency of the vehicle 1 (i.e., in such a manner that the vehicle 1 cruises) (step S115). Then, the step S101 may be performed again after a lapse of a predetermined time (e.g., several ten milliseconds to several hundred milliseconds). In other words, the vehicle control process illustrated in FIG. 2 may be repeated with a period corresponding to the predetermined time.

In the determination in the step S102, if it is determined that there is a preceding vehicle (the step S102: Yes), the preceding vehicle risk degree determinator 17 (refer to FIG. 1) determines the risk degree of the preceding vehicle (step S103).

The vehicle control apparatus 100 determines whether or not the preceding vehicle is safe, on the basis of a result of the step S103 (step S104). When the risk degree is defined in the plurality of gradations, the vehicle control apparatus 100 may determine that the preceding vehicle is safe if the risk degree is less than a predetermined risk degree threshold value. On the other hand, when the risk degree is defined in the two gradations, the vehicle control apparatus 100 may determine that the preceding vehicle is safe if the risk degree is “0”.

In the determination in the step S104, if it is determined that the preceding vehicle is safe (the step S104: Yes), the passing possibility determinator 16 (refer to FIG. 1) determines whether or not the vehicle 1 can pass the preceding vehicle at a normal relative speed (e.g., at less than 10 km/h) (step S105).

The vehicle control apparatus 100 determines whether or not it is possible to pass the preceding vehicle, on the basis of a result of the step S105 (step S106). In the determination, if it is determined that it is possible to pass to pass the preceding vehicle (the step S106: Yes), the passing device setting unit 18 (refer to FIG. 1) generates a passing trajectory (i.e., a target driving route), which is for the vehicle 1 to pass the preceding vehicle at the normal relative speed (step S107). The vehicle controller 19 controls the vehicle 1 to run in accordance with the generated passing trajectory. As a result, the vehicle 1 passes the preceding vehicle (step S108). Then, the step S101 is performed again after a lapse of a predetermined time.

On the other hand, in the determination in the step S106, if it is determined that it is not possible to pass to pass the preceding vehicle (the step S106: No), the vehicle controller 19 controls the vehicle 1 in such a manner that the vehicle 1 follows the preceding vehicle while keeping a predetermined inter-vehicle distance (step S109). Then, the step S101 is performed again after a lapse of a predetermined time.

In the determination in the step S104, if it is determined that the preceding vehicle is not safe (the step S104: No), the passing possibility determinator 16 determines whether or not the vehicle 1 can pass the preceding vehicle at a relative speed that is higher than the normal relative speed (e.g., at 10 kilometers per hour or more) (step S110).

The vehicle control apparatus 100 determines whether or not it is possible to pass the preceding vehicle, on the basis of a result of the step S110 (step S111). In the determination, if it is determined that it is possible to pass the preceding vehicle (the step S111: Yes), the passing device setting unit 18 generates a passing trajectory, which is for the vehicle 1 to pass the preceding vehicle at the relative speed that is higher than the normal relative speed (step S1112). The vehicle controller 19 controls the vehicle 1 to run in accordance with the generated passing trajectory. As a result, the vehicle 1 passes the preceding vehicle (step S113). Then, the step S101 is performed again after a lapse of a predetermined time.

On the other hand, in the determination in the step S111, if it is determined that it is not possible to pass the preceding vehicle (the step S111: No), the vehicle controller 19 controls the vehicle 1 in such a manner that the vehicle 1 follows the preceding vehicle while keeping an inter-vehicle distance that is greater than the predetermined inter-vehicle distance (step S114). Then, the step S101 is performed again after a lapse of a predetermined time.

(Technical Effect)

In the first embodiment, if it is determined that the preceding vehicle is not safe and if it is determined that it is possible to pass the preceding vehicle, the vehicle 1 is controlled to pass the preceding vehicle at the relative speed that is higher than normal. As a result, the vehicle 1 can pass the preceding vehicle in a relatively short time when passing the preceding vehicle that is determined to be not safe, for example, due to relatively large wandering in a road width direction or the like. It is thus possible to reduce a risk associated with the passing, such as a collision between the preceding vehicle and the vehicle 1 when passing. In addition, it is possible to ease a sense of anxiety of an occupant of the vehicle 1 who sees the preceding vehicle that is determined to be not safe.

### Second Embodiment

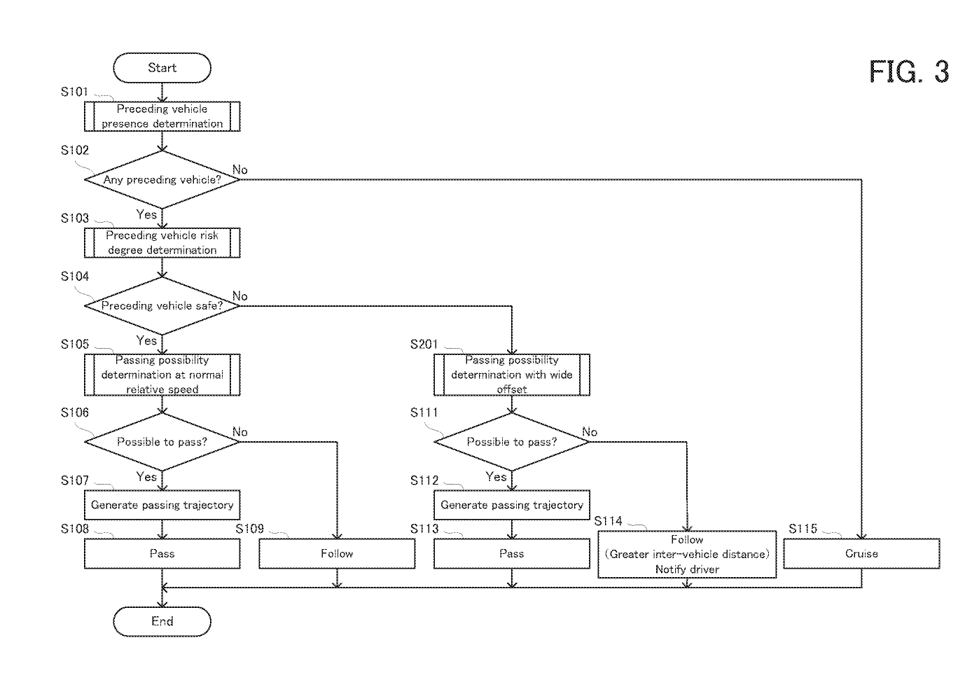

A vehicle control apparatus according to a second embodiment will be explained with reference to FIG. 3. The second embodiment is partially different from the first embodiment in the vehicle control process, but is the same in the other part. Thus, in the second embodiment, an explanation of the same part as that of the first embodiment will be omitted, and the same parts will carry the same reference numerals in the drawing. Basically, only the different point will be explained with reference to FIG. 3.

(Vehicle Control Process)

In the determination in the step S104 described above, if it is determined that the preceding vehicle is not safe (the step S104: No), the passing possibility determinator 16 determines whether or not the vehicle 1 can pass the preceding vehicle after setting a distance between the vehicle 1 and the preceding vehicle in the road width direction (hereinafter referred to as an “offset” as occasion demands) when the vehicle 1 passes the preceding vehicle, to be wider than an offset when the vehicle 1 passes the preceding vehicle and when it is determined that the preceding vehicle is safe (step S201).

Specifically, for example, on the basis of the position and the speed of the preceding vehicle predicted by the preceding vehicle position/speed predictor 15, the passing possibility determinator 16 may determine that it is possible to pass the preceding vehicle, if a distance between a position of the preceding vehicle after a predetermined time from a present time (which is particularly an end position of the preceding vehicle in the road width direction) and an end of the passing lane on the opposite side of a side on which the preceding vehicle exists is sufficiently wider than the offset when the vehicle 1 passes the preceding vehicle and when it is determined that the preceding vehicle is safe (e.g. if the distance is greater than or equal to 3 meters). On the other hand, the passing possibility determinator 16 may determine that it is not possible to pass the preceding vehicle, if the distance is not sufficient.

The vehicle control apparatus 100 determines whether or not it is possible to pass the preceding vehicle, on the basis of a result of the step S201 (step S111). In the determination, if it is determined that it is possible to pass the preceding vehicle (the step S111: Yes), the passing device setting unit 18 generates a passing trajectory, which is for the vehicle 1 to pass the preceding vehicle with the offset that is wider than the offset when the vehicle 1 passes the preceding vehicle and when it is determined that the preceding vehicle is safe (step S1112). The vehicle controller 19 controls the vehicle 1 to run in accordance with the generated passing trajectory. As a result, the vehicle 1 passes the preceding vehicle (step S113). Then, the step S101 is performed again after a lapse of a predetermined time.

(Technical Effect)

In the second embodiment, if it is determined that the preceding vehicle is not safe and if it is determined that it is possible to pass the preceding vehicle, the vehicle 1 is controlled to pass the preceding vehicle with a relatively wide offset. As a result, the vehicle 1 can pass the preceding vehicle with a relatively wide offset when passing the preceding vehicle that is determined to be not safe. Thus, according to the vehicle control apparatus 100, it is possible to reduce the risk associated with the passing.

### Third Embodiment

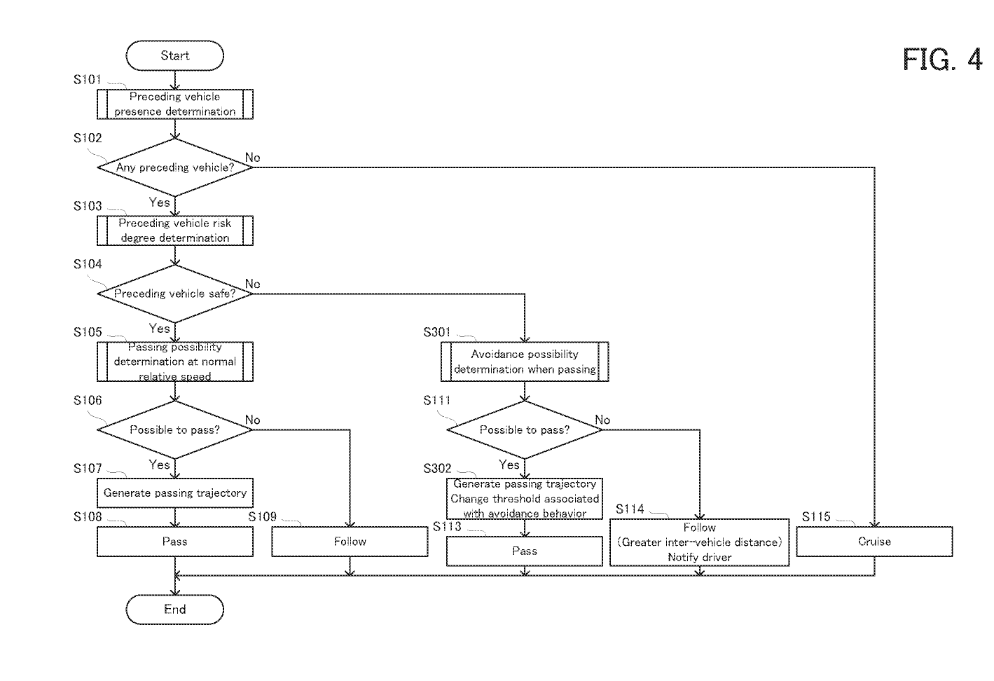

A vehicle control apparatus according to a third embodiment will be explained with reference to FIG. 4. The third embodiment is partially different from the first embodiment in the vehicle control process, but is the same in the other part. Thus, in the third embodiment, an explanation of the same part as that of the first embodiment will be omitted, and the same parts will carry the same reference numerals in the drawing. Basically, only the different point will be explained with reference to FIG. 4.

(Vehicle Control Process)

In the determination in the step S104 described above, if it is determined that the preceding vehicle is not safe (the step S104: No), the passing possibility determinator 16 determines whether or not it is possible to avoid the preceding vehicle when the vehicle 1 passes the preceding vehicle (step S301). Specifically, for example, on the basis of the position and the speed of the preceding vehicle predicted by the preceding vehicle position/speed predictor 15, the passing possibility determinator 16 may determine that it is possible to avoid the preceding vehicle, if a distance between a position of the preceding vehicle after a predetermined time from a present time (which is particularly an end position of the preceding vehicle in the road width direction) and an end of the passing lane on the opposite side of a side on which the preceding vehicle exists is wide enough for the vehicle 1 to exhibit an avoidance behavior. On the other hand, the passing possibility determinator 16 may determine that it is not possible to avoid the preceding vehicle, if the distance is not sufficient.

The vehicle control apparatus 100 determines whether or not it is possible to pass the preceding vehicle, on the basis of a result of the step S301 (step S111). In the step S301, if it is determined that it is possible to avoid the preceding vehicle, the vehicle control apparatus 100 determines that it is possible to pass the preceding vehicle. In this case (the step S111: Yes), the passing device setting unit 18 generates a passing trajectory, which is for the vehicle 1 to pass the preceding vehicle, and changes a threshold value associated with an avoidance behavior control so that the avoidance behavior can be easily exhibited (step S302).

The vehicle controller 19 controls the vehicle 1 to run in accordance with the generated passing trajectory. As a result, the vehicle 1 passes the preceding vehicle (step S113). Then, the step S101 is performed again after a lapse of a predetermined time.

The existing various aspects can be applied to the avoidance behavior control, and an explanation of the details will be thus omitted. Moreover, the passing trajectory generated in the step S302 may be the same as the passing trajectory generated in the step S107.

On the other hand, in the step S301, if it is determined that it is not possible to avoid the preceding vehicle, the vehicle control apparatus 100 determines that it is not possible to pass the preceding vehicle. In this case (the step S111: No), the step S114 is performed.

(Technical Effect)

In the third embodiment, if it is determined that the preceding vehicle is not safe and if it is determined that it is possible to pass the preceding vehicle, the threshold value associated with the avoidance behavior control is changed so that the avoidance behavior can be easily exhibited, and then, the vehicle 1 is controlled to pass the preceding vehicle. As a result, the vehicle 1 can exhibit the avoidance behavior at a relatively early stage, for example, when the preceding vehicle approaches the vehicle 1 in passing the preceding vehicle that is determined to be not safe. Thus, according to the vehicle control apparatus 100, it is possible to reduce the risk associated with the passing.

<Others>

The aforementioned first to third embodiments may be combined. For example, in the determination in the step S104, if it is determined that the preceding vehicle is not safe (the step S104: No), at least two of the steps S110, S210, and S301 may be performed.

In this case, if at least one of the at least two steps is “possible”, i.e., if at least one of the steps performed out of “whether or not the vehicle 1 can pass the preceding vehicle at a relatively high relative speed” (the step S110), “whether or not the vehicle 1 can pass the preceding vehicle with an offset that is wider than the offset when the vehicle 1 passes the preceding vehicle and when it is determined that the preceding vehicle is safe” (the step S201), and “whether or not it is possible to avoid the preceding vehicle” (the step S301), then, the vehicle control apparatus 100 may determine that it is possible to pass the preceding vehicle, in the step S111.

For example, if the steps S110 and S201 are performed and if both are “possible”, the passing device setting unit 18 may generate a passing trajectory, which is for the vehicle 1 to pass the preceding vehicle at the relative speed that is higher than the normal relative speed and with the offset that is wider than the offset when the vehicle 1 passes the preceding vehicle and when it is determined that the preceding vehicle is safe. If only one of the steps S110, S201, and S301 is “possible”, a passing trajectory that is the same as any of those in the first to third embodiments may be generated.

Various aspects of embodiments of the present disclosure derived from the embodiments explained above and a modified example will be explained hereinafter.

A vehicle control apparatus according to an aspect of embodiments of the present disclosure is provided with: a risk degree determinator configured to determine a risk degree of a preceding vehicle, which runs ahead of a host vehicle, on the basis of at least one of a loading aspect and a behavior associated with the preceding vehicle; a setting device configured to set a passing aspect, which is for the host vehicle to pass the preceding vehicle, and configured to set the passing aspect when it is determined that the risk degree of the preceding vehicle is relatively high, to reduce a risk associated with passing in comparison with the passing aspect when it is determined that the risk degree of the preceding vehicle is relatively low; and a controller configured to control the host vehicle to pass the preceding vehicle in the set passing aspect.

In the aforementioned embodiments, the preceding vehicle risk degree determinator 17 corresponds to an example of the risk degree determinator, the passing device setting unit 18 corresponds to an example of the setting device, and the vehicle controller 19 corresponds to an example of the controller.

On the vehicle control apparatus, the risk degree of the preceding vehicle is determined by the risk degree determiantor on the basis of at least one of the loading aspect and the behavior associated with the preceding vehicle. The passing aspect when the risk degree of the preceding vehicle is relatively high is set by the setting device to reduce the risk associated with the passing, in comparison with the passing aspect when the risk degree of the preceding vehicle is relatively low. Therefore, according to the vehicle control apparatus, the host vehicle can pass the preceding vehicle, in view of the behavior of the preceding vehicle or the like, which may influence a driver's psychological state.

In one aspect of the vehicle control apparatus, if it is determined that the risk degree of the preceding vehicle is relatively high, the setting device is configured to set the passing aspect when it is determined that the risk degree of the preceding vehicle is relatively high, (i) to increase a relative speed between the host vehicle and the preceding vehicle when the host vehicle passes the preceding vehicle, (ii) to increase a distance between the host vehicle and the preceding vehicle in a lateral direction of the host vehicle when the host vehicle passes the preceding vehicle, and/or (iii) to allow the host vehicle to perform avoidance control for automatically avoiding an obstacle that exists in surroundings of the host vehicle, and to set a reference for determining whether or not to perform the avoidance control so that the avoidance control can be easily performed, in comparison with when it is determined that the risk degree of the preceding vehicle is relatively low. According to this aspect, it is possible to reduce the risk associated with the passing, relatively easily.

In another aspect of the vehicle control apparatus, the vehicle control apparatus is further provided with a passing determinator configured to determine whether or not the host vehicle can pass the preceding vehicle in the set passing aspect, and the controller is configured to control the host vehicle to pass the preceding vehicle in the set passing aspect on condition that it is determined that the host vehicle can pass the preceding vehicle. According to this aspect, the host vehicle can appropriately pass the preceding vehicle. In the aforementioned embodiments, the passing possibility determinator 16 corresponds to an example of the passing determinator.

The present disclosure may be embodied in other specific forms without departing from the spirit or essential characteristics thereof. The present embodiments and examples are therefore to be considered in all respects as illustrative and not restrictive, the scope of the disclosure being indicated by the appended claims rather than by the foregoing description and all changes which come in the meaning and range of equivalency of the claims are therefore intended to be embraced therein.

What is claimed is:

1. A vehicle control apparatus comprising:
a risk degree determinator configured to determine a risk degree of a preceding vehicle, which runs ahead of a host vehicle, on the basis of at least one of a loading aspect and a behavior associated with the preceding vehicle;
a setting device configured to set a passing aspect, which is for the host vehicle to pass the preceding vehicle, and configured to set the passing aspect when it is determined that the risk degree of the preceding vehicle is relatively high, to reduce a risk associated with passing in comparison with the passing aspect when it is determined that the risk degree of the preceding vehicle is relatively low; and
a controller configured to control the host vehicle to pass the preceding vehicle in the set passing aspect.

2. The vehicle control apparatus according to claim 1, wherein if it is determined that the risk degree of the preceding vehicle is relatively high, said setting device is configured to set the passing aspect when it is determined that the risk degree of the preceding vehicle is relatively high, (i) to increase a relative speed between the host vehicle and the preceding vehicle when the host vehicle passes the preceding vehicle, (ii) to increase a distance between the host vehicle and the preceding vehicle in a lateral direction of the host vehicle when the host vehicle passes the preceding vehicle, and/or (iii) to allow the host vehicle to perform avoidance control for automatically avoiding an obstacle that exists in surroundings of the host vehicle, and to set a reference for determining whether or not to perform the avoidance control so that the avoidance control can be easily performed, in comparison with when it is determined that the risk degree of the preceding vehicle is relatively low.

3. The vehicle control apparatus according to claim 1, wherein
said vehicle control apparatus further comprises a passing determinator configured to determine whether or not the host vehicle can pass the preceding vehicle in the set passing aspect, and
said controller is configured to control the host vehicle to pass the preceding vehicle in the set passing aspect on condition that it is determined that the host vehicle can pass the preceding vehicle.

4. The vehicle control apparatus according to claim 2, wherein
said vehicle control apparatus further comprises a passing determinator configured to determine whether or not the host vehicle can pass the preceding vehicle in the set passing aspect, and
said controller is configured to control the host vehicle to pass the preceding vehicle in the set passing aspect on condition that it is determined that the host vehicle can pass the preceding vehicle.
